(19) United States
(12) Patent Application Publication
(10) Pub. No.: US 2003/0205840 A1
(43) Pub. Date: Nov. 6, 2003

(54) Molded bag and process for manufacture thereof

(76) Inventors: Gail Elaine Hottenroth, San Pedro, CA (US); Craig James Castro, San Pedro, CA (US)

Correspondence Address: JERRY SEMER, 617 CROGHAN ST., FREMONT, OH, 43420, US

(21) Appl. No.: 10/137,462

(22) Filed: May 1, 2002

(51) Int. Cl. B29C 33/40

(52) U.S. Cl. 264/225; 205/70

(57) ABSTRACT

This invention is a method for making purses and other bags. The first part of the process is forming a female mold of the bag. This mold can be formed in extreme detail. The mold is then preheated and colored plastic is then poured into it. The mold is then lowered into a hot oil or salt bath and the plastic and the hot oil or salt reacts causing the plastic to line the interior wall of the mold. The mold is then taken out of the hot oil or salt bath and placed in a cooling tank where the plastic is cooled and sets. The mold is taken out of the cooling tank and the unfinished bag is removed from the mold. The bag is then finished by polishing and adding any accessories such as snaps, zippers, linings, and handles to the bag. The process can be used to form a hard or soft sided bag.

### BACKGROUND OF THE INVENTION

Most purses and soft side bags such as sporting bags are formed by sewing them together, or molded by an injection molding process. To produce bags by these processes is expensive and time consuming. Thus, one of the objectives to this invention is to create a bag by a process that is less expensive and less time consuming than by sewing the bag together, or injection molding. The inventor concluded that it would be easier to manufacture and less expensive and time consuming if the bag or purse could be slush molded rather than sewn or injection molded. The low cost is attributed to low mold costs and the economy of small production runs. Thus, one of the objectives of this invention is to create a hand bag or purse that is molded and exhibits extreme detail. Further, most molded purses, up to this time have looked very simple and unappealing in appearance. Thus, one of the objectives of this invention is to create a molded purse/bag that is very detailed in appearance.

Applicant has utilized a slush molding method for creating purses/bags that are attractive and detailed. In fact, applicant can make his purse/bag look almost like any other purse/bag on the market. The molding process can produce a purse/bag with a great deal of detail including various surface textures and stitch lines. The process can also be used to produce a purse/bag that looks like it is made out of leather or cloth or other material.

A feature that allows the inventor to meet these objectives is that he has found a molding process that enables the molder to produce a hard side bag or flexible side bag that has extremely detailed characteristics. It is possible with this process to copy a bag already in the market place in exacting detail, or create an entirely new 3 dimensionally shaped purse or bag.

### SUMMARY OF THE INVENTION

This invention is a method for making purses and other bags. The first part of the process is forming a female mold of the bag. This mold can be formed in extreme detail. The mold is then preheated and colored plastic is then poured into it. The mold is then lowered into a hot oil or salt bath and the plastic and the hot oil or salt reacts causing the plastic to line the interior wall of the mold. The mold is then taken out of the hot oil or salt bath and placed in a cooling tank where the plastic is cooled and sets. The mold is taken out of the cooling tank and the unfinished bag is removed from the mold. The bag is then finished by polishing and adding any accessories such as snaps, zippers, linings, and handles to the bag. The process can be used to form a hard or soft sided bag.

### BRIEF DESCRIPTION OF THE DRAWINGS

FIG. 1 is a view of the mixing cylinder.

FIG. 2 is a view of the plastic being poured into the mode.

FIG. 3 is a view of the molds being lowered into the hot oil bath.

FIG. 4 is a view of the molds being lowered into the cooling tank.

FIG. 5 is a view of the unfinished bags being removed from the mold.

FIG. 6 is a step diagram showing the seven steps used in making the molds for the creation of the bag.

### DETAILED DESCRIPTION OF THE PREFERRED EMBODIMENT

The first step in the process of manufacturing a purse or a bag is to create the mold 10. For this process, a female mold 10 is needed. The mold 10 is usually created out of copper, aluminum or nickel, however, other suitable materials can be used. In the usual case the mol can be made out of any material that can withstand 300 to 400 degrees F. and the liquid plastic and plasiticizer. The mold 10 can be made with extreme detailed characteristics. The mold 10 can show the surface texture of the object and stitch lines.

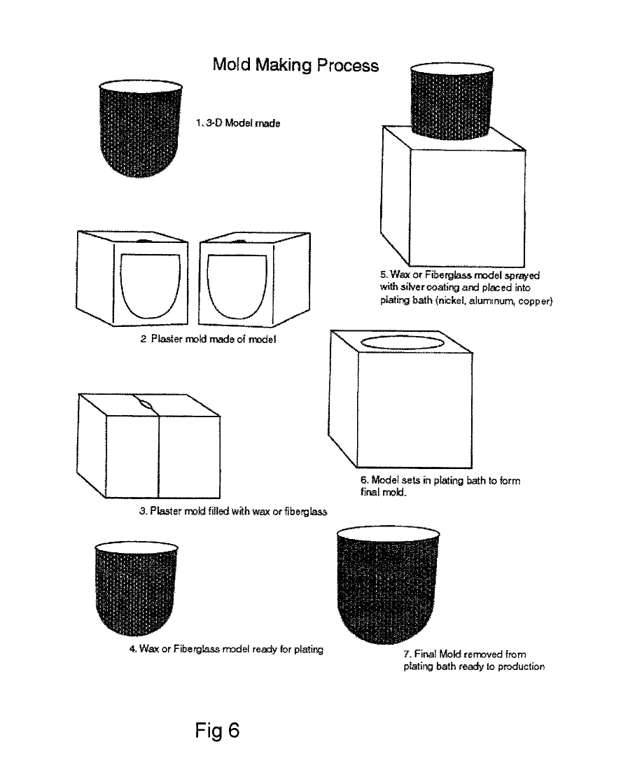

FIG. 6 shows the steps in making a mode. One of the easiest ways to make this mold 10 is to use a model of the final product as shown in step 1 of FIG. 6. In step 2 the model is used to make a plaster cast. In step 3 a fiberglass or wax negative is made by filling plaster the cast with wax or fiberglass. The negative is then sprayed with silver and placed in a plating bath of nickel copper or aluminum for an elapsed time. After the elapsed time the plating bath hardens and becomes the final mold. The fiberglass or wax is removed creating a cavity mold. This allows the mold 10 to be created in extreme detail. If the purse/bag used to copy is has been used/worn even the marking from the wear and tear could be reproduced.

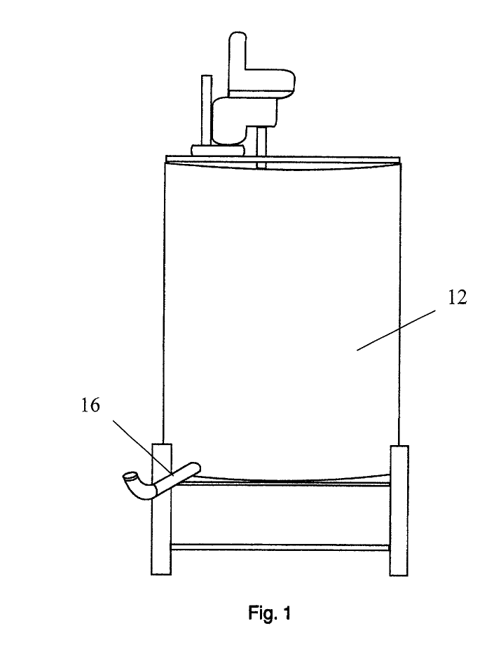

The next step in the process is to mix the plastic with the plasiticizer. In the preferred embodiment this is done in a giant mixer 12 as shown in FIG. 1. In the preferred embodiment the plastic is polyvinylchloride. The next step is to add the color to the plastic and plasticizer. This is also done in the giant mixer 12 shown in FIG. 1. The color pigment can be poured in the mixer and slowly mixed with the plastic to create one color. The color could also just be semi-mixed so it doesn't quite mix thoroughly with the plastic. This could be done with mixing several colors so that the end product would be a plastic without a thoroughly mixed color or be a plastic that has several colors within it.

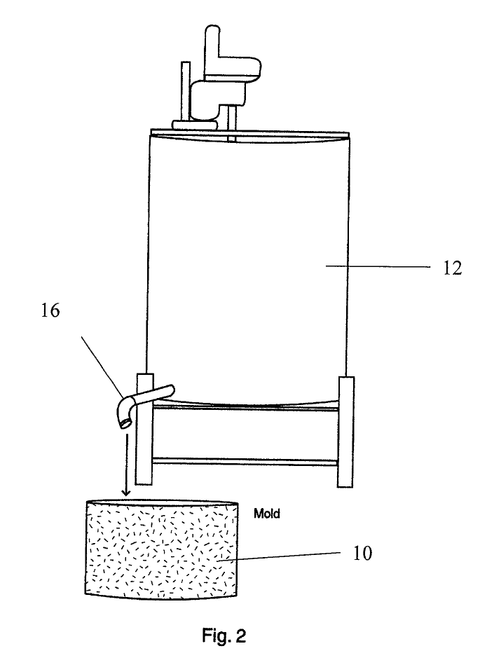

However, in the usual case, individuals want one color items and thus, the plastic would be thoroughly mixed. Once the plastic is mixed, then you move on to step three which is poring the plastic in the mold already created. This is shown in FIG. 2. FIG. 2 shows the large mixing cylinder of mixer 12, a pouring nozzle 16 and the mold 10. The mold 10, before the plastic is placed into it, is preheated. The mold in the preferred embodiment is preheated to approximately 350 degrees Fahrenheit. The plastic, which has been thoroughly mixed in the mixing cylinder of the mixer 12 flows through the pouring nozzle 16 and into the mold 10.

Once the mold 10 is filled to the proper height with plastic it is moved to the next step; the hot oil or salt bath. The mold 10 is then dipped into the hot oil or salt bath 18 which in the preferred embodiment is also approximately 350 degrees Fahrenheit.

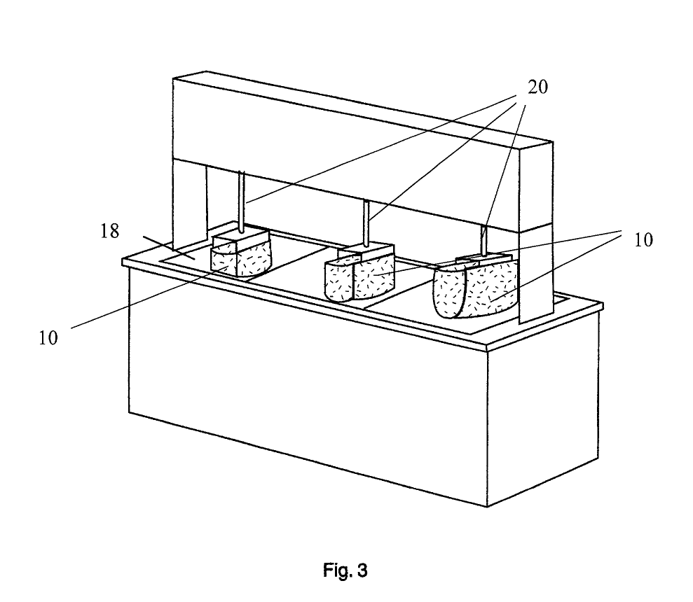

The dipping of the mold in the hot oil or salt bath is shown in FIG. 3. FIG. 3 shows the hot oil or salt bath 18, the mold 10 and the mold hanger 20. The mold hanger 20 is slowly lowered into the hot oil or salt bath 18. The reaction between the liquid plastic and the hot oil or salt causes the liquid plastic to line the interior wall of the mold 10 and to set the plastic.

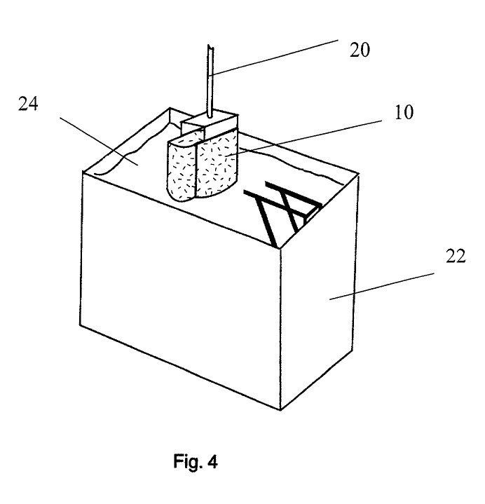

The mold 10 is then taken out of the hot oil or salt bath by raising the mold hanger 20 and moved to the next step shown in FIG. 4. FIG. 4 shows the cooling tank 22 which is filled with a cooling liquid 24, the mold 10 and the mold hanger 20. The mold hanger 20 is lowered into the cooling tank 22 and the cooling liquid 24 cools the plastic that is set inside the mold 10. The mold 10 is then lifted from the cooling tank 22 by rising the mold hanger 20 and now the plastic bag 24 inside the mold 10 is ready to be removed.

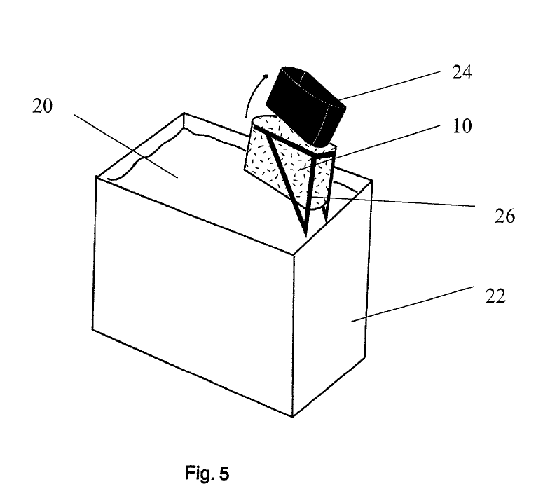

FIG. 5 shows the next step in the process; the removal of the bag 24 from the mold 10. In FIG. 5 one sees the cooling tank 22, the mold 10, and mold removal basket 26. The mold 10 is placed in the mold removal basket 26 and the unfinished plastic bag 24 is removed from the inside of the mold 10.

The unfinished plastic bag 24 is taken from the mold 10 and polished. Also added to the unfinished bag could be pins, zippers, interior linings, carrying handles, shoulder straps, wheels, pull handles, fittings such as Drings, clips, snaps, buckles, Velcro and logos. This bag is produced with exquisite detail from the mold. Once this step, the finishing step is performed the bag 24 is ready for market.

The bag 24 can look like it is made out of leather and is sewn together. The thickness of the bag 25 is controlled by the amount of plastic placed in the mold 10 and the temperature and time in which the mold 10 is placed in the hot oil or salt bath 18. The type of plastic and the time and temperature of the hot oil or salt bath 18 can also control the flexibility of the bag 24. The bag can be made flexible so that is looks like cloth or it can be made hard like a hard sided suitcase. The process can be used not only to make purse but also handbags, luggage, electronic equipment cases, sporting equipment cases, water-proof sport bags, armoires bags and accessory cases.

Changes and modifications in the specifically described embodiments can be carried out without departing from the scope of the invention which is intended to be limited only by the scope of the appending claims.

1. A molded bag prepared by a process comprising the steps of:
a. Creating a mold of a bag; and,
b. Pouring plastic with plasiticizer into the mold; and,
c. Lowering the mold into a bath which causes the plastic to line the interior wall of the mold for a length of time and at temperature then removing the mold from the bath; and,
d. Placing the mold in a cooling tank for cooling and setting the plastic for a length of time and at a temperature then removing the mold from the bath; and,
e. Removing the molded plastic from the mold; and,
f. Polishing the plastic; and,
g. Adding accessories to the plastic to produce the bag.

2. A molded bag prepared by a process as in claim 1 further comprising the step of:
a. mixing the plastic and plasiticizer

3. A molded bag prepared by a process as in claim 2 further comprising the step of:
a. mixing the plastic and with a color pigment.

4. A molded bag prepared by a process as in claim 2 further comprising the step of:
a. preheating the mold before the mixture of plastic and plasiticizer is added.

5. A molded bag prepared by a process as in claim 1 wherein:
a. the bath is a hot oil bath

6. A molded bag prepared by a process as in claim 1 wherein:
a. The bath is a salt bath.

7. A molded bag prepared by a process as in claim 1 wherein:
a. the method for creating the mold is as follows:
b. placing a pliable substance over the model of the final product to create a negative; and,
c. removing the negative from the model of the final product; and,
d. spraying the negative with conductive substance; and
e. placing the negative with the conductive substance in a plating bath of a metal and plating the negative with the metal; and,
f. removing the negative from the created mold.

8. A molded bag prepared by a process as in claim 4 wherein:
a. the pliable substance is wax.

9. A molded bag prepared by a process as in claim 7 wherein:
a. the pliable substance is plaster.

10. A molded bag prepared by a process as in claim 7 wherein:
a. the metal is copper.

11. A molded bag prepared by a process as in claim 7 wherein:
a. the metal is nickel.

12. A molded bag prepared by a process as in claim 7 wherein:
a. the metal is aluminum.

13. A purse prepared by a process comprising the steps of:
a. creating a mold of a purse; and,
b. pouring plastic with plasiticizer into the mold; and,
c. lowering the mold into a bath which causes the plastic to line the interior wall of the mold for a length of time and at temperature then removing the mold from the bath; and,
d. placing the mold in a cooling tank for cooling and setting the plastic for a length of time and at a temperature then removing the mold from the bath; and,
e. removing the molded plastic from the mold; and,
f. polishing the plastic; and,
g. adding accessories to the plastic to produce the purse.

14. A purse prepared by a process as in claim 13 further comprising the step of:
a. mixing the plastic and plasiticizer

15. A purse prepared by a process as in claim 14 further comprising the step of:
a. mixing the plastic and with a color pigment.

16. A purse prepared by a process as in claim 14 further comprising the step of:
a. preheating the mold before the mixture of plastic and plasiticizer is added.

17. A purse prepared by a process as in claim 13 wherein:
a. the method for creating the mold is as follows:
b. placing a pliable substance over the model of the final product to create a negative; and,
c. removing the negative from the model of the final product; and,
d. spraying the negative with conductive substance; and
e. placing the negative with the conductive substance in a plating bath of a metal and plating the negative with the metal; and,
f. removing the negative from the created mold.

18. A molded bag prepared by a process as in claim 17 wherein:
a. the pliable substance is wax.

19. A purse prepared by a process as in claim 17 wherein:
a. the pliable substance is plaster.

20. A purse prepared by a process as in claim 17 wherein:
a. the metal is copper.
